(19) United States
(12) Patent Application Publication
(10) Pub. No.: US 2026/0241504 A1
(43) Pub. Date: Aug. 20, 2026

(54) MACHINE TOOL SYSTEM WITH TOOL BASE AND FIXTURE PLATE

(71) Applicant: Rolls-Royce Corporation, Indianapolis, IN (US)

(72) Inventors: Rusty Garner, Indianapolis, IN (US); Damon Ward, Indianapolis, IN (US)

(21) Appl. No.: 19/056,693

(22) Filed: Feb. 18, 2025

(51) Int. Cl. B23Q 3/18

(52) U.S. Cl. CPC B23Q 3/18; B23Q 2716/00

(57) ABSTRACT

A machine tool system with a fixture plate for repeatably positioning and repositioning a workpiece relative to a tool is disclosed in this paper. In an illustrated embodiment, the system includes a tool base, a tool mounted to the tool base to move along a tool axis, and a fixture plate coupled to the tool base and supporting the workpiece for modification by the tool. The fixture plate shown in the example includes smooth-wall locating holes, threaded holes, elongated mounting holes, and an alignment bore. Openings included in the fixture plate allow for precise predetermined positioning of the workpiece relative to the tool.

### FIELD OF THE DISCLOSURE

The present disclosure relates generally to machine tool systems, and more specifically to systems incorporating fixture plates.

### BACKGROUND

Electrochemical machining (ECM) is a non-contact, non-thermal material removal process capable of creating small features, high quality surfaces, and high repeatability for production parts. Pulsed electrochemical machining (PECM), sometimes called precision electrochemical machining, is a more precise variant of ECM that uses a pulsed power supply.

Unlike many other manufacturing processes, there is no contact between the machining component or tool bit, which may be referred to as a cathode, and the workpiece in PECM. Material of the workpiece in close proximity to the machining component is dissolved by an electrochemical process, and the by-products are flushed away with a flowing electrolyte. The resulting workpiece has the shape that is an inverse of the machining component.

PECM provides some advantages over other manufacturing processes. For example, PECM may be used for relatively hard materials that may be difficult to machine using conventional methods. As another example, PECM can be used to machine small, intricate, or complex shapes or contours with a relatively high surface quality. Because of the precision of PECM tools, similarly precise positioning and repositioning of a workpiece relative to the tool can be helpful.

### SUMMARY

The present disclosure may comprise one or more of the following features and combinations thereof.

According to the present disclosure, a machine tool system illustratively includes a tool base, a tool, and a fixture plate. The tool base is adapted to support a workpiece above an underlying floor. The tool is mounted for movement relative to the machine base along a tool axis and configured to modify the workpiece upon interaction therewith. The fixture plate is fixed to the tool base and configured to locate the workpiece in a preselected position along the tool axis for modification by the tool.

In illustrated embodiments, the fixture plate includes a panel, a pattern of round holes, and an alignment bore. The alignment bore is centered around the tool axis so as to confirm alignment of the tool with the fixture plate and ensure precise modification of the workpiece during machining.

In illustrated embodiments, the pattern of round holes include smooth-sided locating holes configured to receive locating pins fixed to the workpiece. Locating pins inserted into the smooth-sided locating holes set the preselected location of the workpiece. The threaded holes are configured to receive threaded fasteners to hold the workpiece in place relative to the fixture plate. In some embodiments, the smooth-sided locating holes and threaded holes alternate along rows across the panel.

In illustrated embodiments, the smooth-sided locating holes are formed in hardened inserts inlaid into the panel. In some embodiments, the hardened inserts are press fit into the panel. In some embodiments, the panel comprises stainless steel material and the hardened inserts comprise carbide material.

In illustrated embodiments, the tool can include an electrode configured for use in electrochemical machining of the workpiece. The electrode is mounted for movement only along the tool axis.

In illustrated embodiments, the fixture plate further includes elongated mounting holes. The elongated mounting holes form racetrack shapes when the fixture plate is viewed from above. The elongated mounting holes receiving fasteners coupling the fixture plate to the tool base so that a top surface of the fixture plate defines a plane perpendicular to the tool axis.

In illustrated embodiments, the pattern of round holes are arranged in rows across the panel and the elongated mounting holes are arranged out of alignment with the rows. In some embodiments, the elongated mounting holes are spaced apart from each of the other at least three elongated mounting holes by at least one row formed by the pattern of round holes.

In some illustrated embodiments, the fixture plate includes a panel, a pattern of round holes, and elongated mounting holes. The elongated mounting hoes can form racetrack shapes when the fixture plate is viewed from above. The elongated mounting holes receive fasteners coupling the fixture plate to the tool base so that a top surface of the fixture plate defines a plane perpendicular to the tool axis.

These and other features of the present disclosure will become more apparent from the following description of the illustrative embodiments.

### BRIEF DESCRIPTION OF THE DRAWINGS

FIG. 1 is a side elevation view of a machine tool system including a tool base, a tool mounted to the tool base to move along a tool axis, and a fixture plate coupled to the tool base and supporting a frame-mounted workpiece in position along the tool axis for modification by the tool;

FIG. 2A is a perspective view of the fixture plate showing that the fixture plate includes locating holes (formed in hardened inserts) alternating with threaded holes, elongated mounting holes, and a alignment bore designed to be aligned with the tool axis during confirmation of proper relative location of the fixture plate relative to the tool;

FIG. 2B is another perspective view of the fixture plate of FIG. 2A;

FIG. 3 is a perspective view of a portion of the fixture plate from FIG. 2A with the hardened inserts exploded away from a panel and showing the threads formed in the panel to provide the threaded holes included in the fixture plate; and

FIG. 4 is another side elevation view of the machine tool system and fixture plate of FIG. 1.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

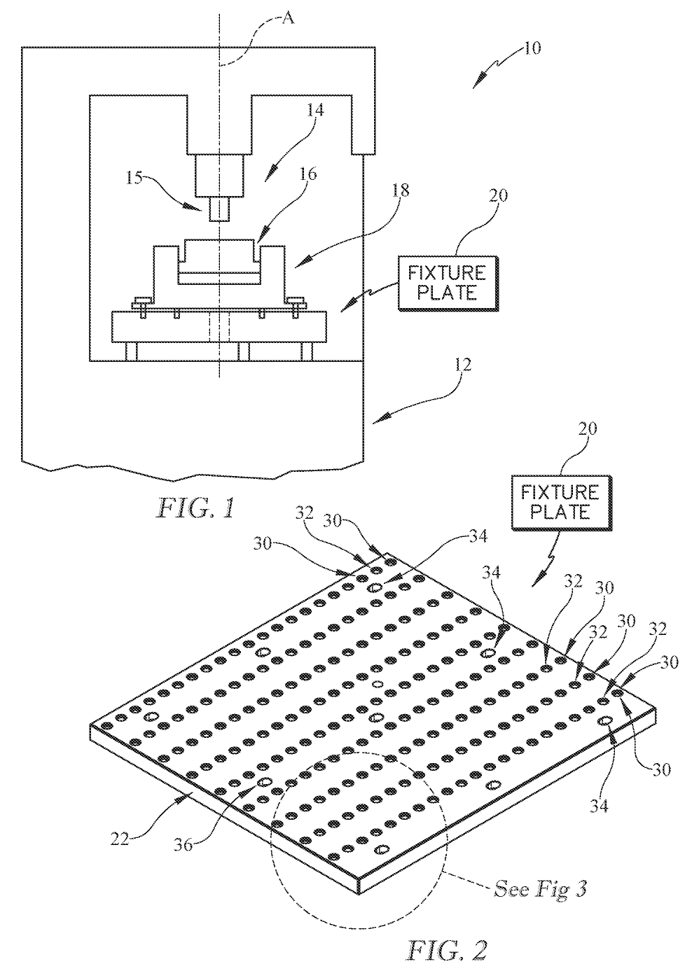

A machine tool system 10 with a fixture plate 20 for repeatably positioning and repositioning a workpiece 16 relative to a tool 14 is shown in FIG. 1. The machine tool system 10 is illustratively configured for pulsed electrochemical machining via a single axis electrode moving along a vertical tool axis A. However, the teachings of this disclosure is applicable to other single-axis and multi-axis machine tool systems where repeatable and precise locating of a workpiece for modification by a tool is desired.

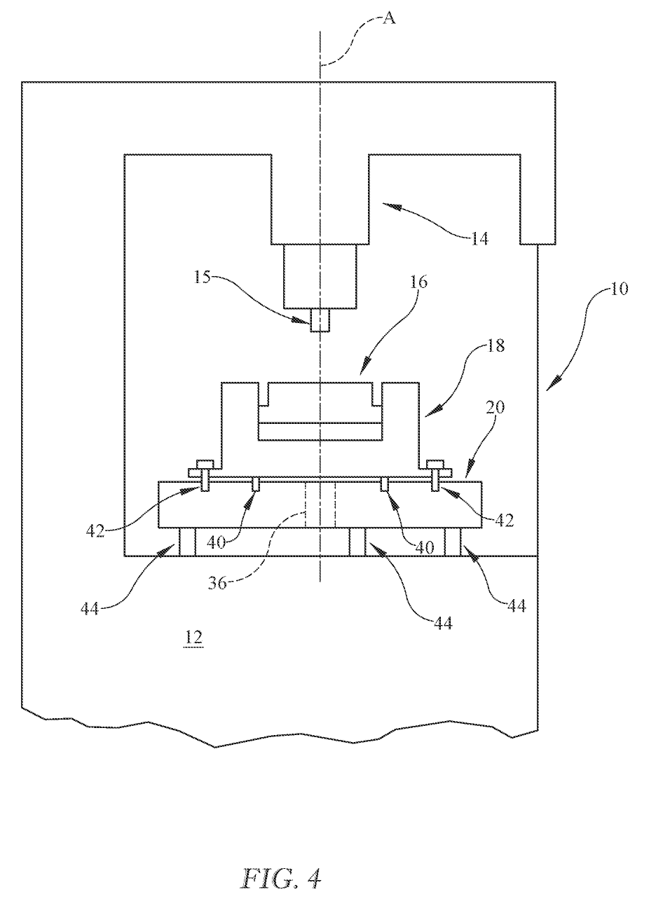

The machine tool system 10 illustratively includes a tool base 12, a tool 14, a workpiece 16, and the fixture plate 20 as shown in FIGS. 1 and 4. The tool base 12 is adapted to support the workpiece above an underlying floor and can house components used to control the tool 14. The tool 14 is mounted to the tool base 12 for movement relative to the tool base along the tool axis A. The tool 14 illustratively includes an electrode 15 configured to modify the workpiece upon interaction therewith. The exemplary workpiece 16 is fixed to a frame 18 designed to support the workpiece 16 during machining. However, in other embodiments, the workpiece 16 may be self supported.

The fixture plate 20 is fixed to the tool base via fasteners as suggested in FIGS. 1 and 4 . The fixture plate 20 allows for precise and repeatable locating of the workpiece in a preselected position along the tool axis A for modification by the tool 14.

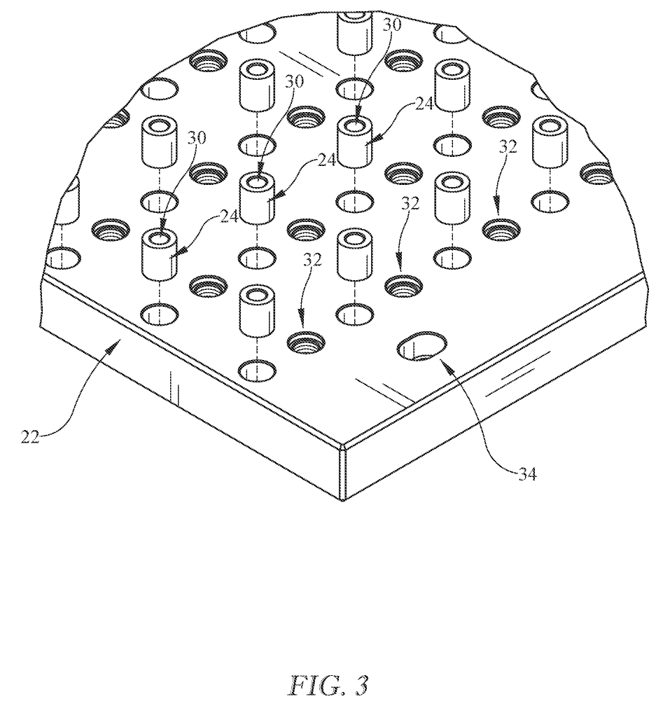

The fixture plate 20 is made up of a panel 22 and inserts 24 press fit into the panel 22 as suggested in FIG. 3. The panel 22 is illustratively made from 300 series stainless steel material suitable for exposure to electrochemical etching environments. The inserts 24 are hardened and made from carbide materials and have a hardness greater than that of the stainless steel used in the panel 22. In this way, locating holes 30 formed in the inserts provide hard points suitable for precise location across the panel 22.

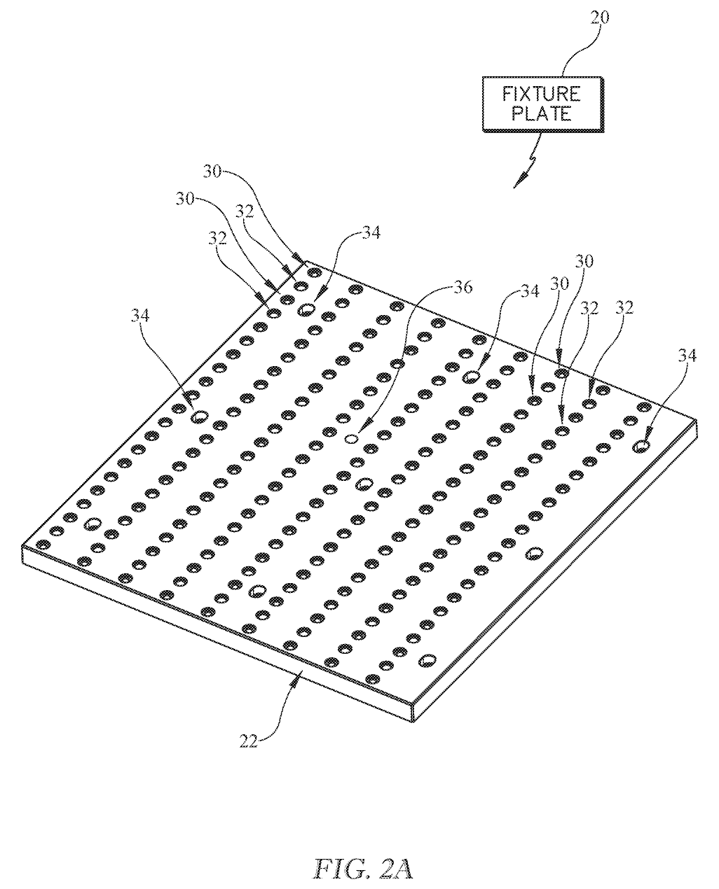

The fixture plate 20 includes locating holes 30, threaded holes 32, mounting holes 34, and an alignment bore 36 as shown in FIGS. 2A and 2B. The locating holes 30 are smooth- sided and are adapted to receive locating pins or dowels 40 associated with the workpiece 16 to precisely position the workpiece 16. The threaded holes 32 are adapted to receive threaded fasteners 42 associated with the workpiece 16 to allow for coupling of the workpiece 16 to the fixture plate 20. The mounting holes 34 extend through the panel 22 of the fixture plate 20 and receive threaded fasteners 44 to couple the fixture plate 20 to the tool base 12. The alignment bore 36 is centered around the tool axis A and is used to confirm alignment of the tool 14 with the fixture plate 20 and the workpiece 16. The alignment bore 36 is larger in diameter than the other holes 30, 32 to avoid use for mounting workpiece. These features of the fixture plate 20 can ensure precise modification of the workpiece 16 during machining.

The locating holes 30 and the threaded holes 32 are illustratively round holes as shown in FIGS. 2A, 2B, and 3. The locating holes 30 and threaded holes 32 are arranged in rows across the panel 22 and alternate – locating, threaded, locating, threaded – to form a generally grid-type pattern. In the illustrated example, the grid pattern of locating holes 30 and threaded holes 32 are arranged in a one inch by one inch pattern.

As noted above, the locating holes 30 are formed in inserts 24 that are press fit into the panel 22. The locating holes 30 are formed through the inserts 24. In other embodiments, the locating holes 30 could be directly formed in the panel 22. The threaded holes 32 are bored and tapped through the panel 22. In other embodiments, the threaded holes 32 could be provided in inserts in or on the panel 22. While the locating holes 30 and the threaded holes 32 are illustratively through holes, they could be blind holes in other embodiments.

The mounting holes 34 are illustratively elongated to have an oval, oblong, racetrack shape when the fixture plate 20 is viewed from above as suggested in FIGS. 2A and 2B. The exemplary fixture plate 20 has nine mounting holes 34 that each extend through the panel 22. The mounting holes are arranged in rows of three at different positions along the panel 22. Each row of mounting holes 34 is arranged out of alignment with rows made up of alternating locating holes 30 and threaded holes 32. The mounting holes 34 receive fasteners 35 that couple the fixture plate 20 to the tool base 12 so that a top surface 21 of the fixture plate 20 defines a plane perpendicular to the tool axis A.

The alignment bore 36 is arranged around the tool axis A when the fixture plate 20 is coupled to the tool base 12. The alignment bore 36 is used to confirm alignment of the tool 14 with the fixture plate 20 and ensure precise modification of the workpiece 16 during machining. The alignment bore 36 is illustratively a round through hole and can be sized to receive an alignment tool head coupled to the tool 14 that extends into the bore 36 to test alignment. The bore 36 can be a blind hole and/or can be non-round. In the illustrative embodiment, the alignment bore 36 is the alignment bore is arranged out of alignment with the rows made up of alternating locating holes 30 and threaded holes 32.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A machine tool system, the system comprising
a tool base adapted to support a workpiece above an underlying floor,
a tool mounted for movement relative to the machine base along a tool axis and configured to modify the workpiece upon interaction therewith, and
a fixture plate fixed to the tool base and configured to locate the workpiece in a preselected position along the tool axis for modification by the tool, the fixture plate including a panel, a pattern of round holes, and an alignment bore centered around the tool axis so as to confirm alignment of the tool with the fixture plate and ensure precise modification of the workpiece during machining.

2. The system of claim 1, wherein the pattern of round holes include smooth-sided locating holes configured to receive locating pins fixed to the workpiece thereby setting the preselected location of the workpiece and threaded holes configured to receive threaded fasteners to hold the workpiece in place relative to the fixture plate.

3. The system of claim 2, wherein the smooth-sided locating holes and threaded holes alternate along rows across the panel.

4. The system of claim 2, wherein the smooth-sided locating holes are formed in hardened inserts inlaid into the panel.

5. The system of claim 4, wherein the hardened inserts are press fit into the panel.

6. The system of claim 4, wherein the panel comprises stainless steel material and the hardened inserts comprise carbide material.

7. The system of claim 6, wherein the tool includes an electrode configured for use in electrochemical machining of the workpiece, and wherein the electrode is mounted for movement only along the tool axis.

8. The system of claim 1, wherein the fixture plate further includes at least three elongated mounting holes that form racetrack shapes when the fixture plate is viewed from above, the at least three elongated mounting holes receiving fasteners coupling the fixture plate to the tool base so that a top surface of the fixture plate defines a plane perpendicular to the tool axis.

9. The system of claim 8, wherein the pattern of round holes are arranged in rows across the panel and the at least three elongated mounting holes are arranged out of alignment with the rows.

10. The system of claim 9, wherein each of the at least three elongated mounting holes are spaced apart from each of the other at least three elongated mounting holes by at least one row formed by the pattern of round holes.

11. The system of claim 9, wherein the pattern of round holes include smooth-sided locating holes and threaded holes.

12. The system of claim 11, wherein the smooth-sided locating holes and threaded holes alternate along the rows across the panel.

13. A machine tool system, the system comprising
a tool base adapted to support a workpiece above an underlying floor,
a tool mounted for movement relative to the machine base along a tool axis and configured to modify the workpiece upon interaction therewith, and
a fixture plate fixed to the tool base and configured to locate the workpiece in a preselected position along the tool axis for modification by the tool, the fixture plate including a panel, a pattern of round holes, and at least three elongated mounting holes that form racetrack shapes when the fixture plate is viewed from above, wherein the at least three elongated mounting holes receive fasteners coupling the fixture plate to the tool base so that a top surface of the fixture plate defines a plane perpendicular to the tool axis.

14. The system of claim 13, wherein the pattern of round holes are arranged in rows across the panel and the at least three elongated mounting holes are arranged out of alignment with the rows.

15. The system of claim 14, wherein each of the at least three elongated mounting holes are spaced apart from each of the other at least three elongated mounting holes by at least one row formed by the pattern of round holes.

16. The system of claim 14, wherein the pattern of round holes include smooth-sided locating holes and threaded holes.

17. The system of claim 16, wherein the smooth-sided locating holes and threaded holes alternate along the rows across the panel.

18. The system of claim 16, wherein the smooth-sided locating holes are formed in hardened inserts press fit in the panel.

19. The system of claim 13, wherein the fixture panel includes a alignment bore centered around the tool axis.

20. The system of claim 19, wherein the pattern of round holes are arranged in rows across the panel and the alignment bore is arranged out of alignment with the rows.
